(19) United States
(12) Patent Application Publication
(10) Pub. No.: US 2017/0312761 A1
(43) Pub. Date: Nov. 2, 2017

(54) ACTIVE ROTATING SEPARATOR

(71) Applicant: Vetco Gray Scandinavia AS, SANDVIKA (NO)

(72) Inventors: Luciano Emanuel PATRUNO, Sandvika (NO); Jose Luis PLASENCIA CABANILLAS, Sandvika (NO); Espen HAUGE, Sandvika (NO)

(21) Appl. No.: 15/525,635

(22) PCT Filed: Nov. 9, 2015
(86) PCT No.: PCT/EP2015/076094

§ 371 Date: May 10, 2017

(30) Foreign Application Priority Data
Nov. 10, 2014 (NO) 20141343

(51) Int. Cl. B04B 9/02; B01D 17/02; B01D 19/00; B04B 1/02

(52) U.S. Cl. CPC B04B 9/02; B04B 1/02; B01D 17/0217; B01D 19/0057

(57) ABSTRACT

An active rotating separator is disclosed, comprising a separator drum arranged to receive multiphase fluid via an upstream end and to deliver separated fluid phases from a downstream end of the drum. An electric motor is installed in the flow through the drum, the motor operable to generate rotation in the fluid flow that passes through the drum, the motor comprising an open rotor permitting through-flow of fluid through the motor.

### TECHNICAL FIELD OF THE INVENTION

The present invention relates to active separators of a type that is driven in rotation in order to effect separation of fluid fractions of different densities, as well as separation of fluid and solid particles, by centrifugal or cyclonic action.

### BACKGROUND AND PRIOR ART

Separation of lighter fluid fractions from heavier fluid fractions in a multiphase fluid is often required in pumping and compression processes. In hydrocarbon production, e.g., separators may be applied for separation of gas from oil and water, for separation of oil from water and solids, as well as for separation of solids, such as sand, from water. If not otherwise stated, the term “multiphase” fluid as used herein shall be understood to cover liquid, gas and solid particles that may be included in a flow of liquid and/or gas.

Separators for separation of fluid fractions or fluid phases in a multiphase fluid can be categorized in passive and active or dynamic separators. A passive separator typically relies on gravity to cause the heavier fraction to accumulate in a bottom zone of the separator, whereas an active separator may be driven to generate rotation in the fluid by which the heavier fraction is forced to accumulate in a peripheral zone of a separator vessel due to centrifugal or cyclonic action.

### SUMMARY OF THE INVENTION

An object of the present invention is to provide a compact and operationally reliable alternative to existing active rotating separators.

Another object of the present invention is to provide an active rotating separator of modular structure which can be assembled and readily adapted for installation in various implementations and at a wide range of production sites.

Still another object of the present invention is to provide an active rotating separator of a standardized design which can be upsized or downsized to meet the capacity requirement for a specific implementation or production site.

Yet another object of the present invention is to provide an active rotating separator designed for simplified installation in a process line together with associated process units, such as boosters, mixers, pumps and compressors, etc.

One or more of these objects is met in an active rotating separator comprising:
a separator drum, in an upstream end arranged to receive a multiphase fluid flow and in a downstream end arranged to deliver separated fluid phases,
an electric motor installed in the fluid flow through the drum, the motor operable to rotate the drum and thereby generate rotation in the flow that passes through the drum, the motor comprising an open rotor permitting the fluid to flow through the motor.

The motor is preferably a permanent magnet (PM) motor wherein permanent magnets are carried in the rotor periphery and electromagnets and stator coils are supported on a casing surrounding the rotor. An inner ring of permanent magnets and an outer ring of associated electromagnets and stator coils may constitute a motor stage in the separator, a motor stage which can be individually powered and controlled.

In one embodiment the permanent magnets are carried on the periphery of the separator drum which is rotatably supported in an outer cylinder that holds the electromagnets and stator coils in surrounding relation to the drum and the permanent magnets.

In one embodiment a number of rotor blades are arranged inside the rotating drum. These rotor blades may be realized as wings reaching inwards from the inner periphery of the drum, the blades or wings running mainly in the longitudinal direction of the drum. The wings may extend along the inner periphery of the drum in parallel orientation with the centre axis, or they may be arranged at an angle relative to the centre axis. The wings may alternatively be helically curved.

The motor stage can be located at any appropriate longitudinal position of the separator drum. In one embodiment the motor stage is located at a longitudinal centre of the drum. In other embodiments a motor stage may be located closer to or at the upstream and/or downstream ends of the drum.

In other embodiments the motor can be comprised of two or more motor stages. In embodiments including multiple motor stages each motor stage can be individually powered and controlled, or all motor stages can be controlled in common.

The length of the drum can be varied down to the axial dimension of one or more motor stages arranged in series.

One alternative embodiment comprises a perforated drum which is non-rotationally supported in a cylinder, the cylinder defining an annular space about the drum. An internal screw in the drum is driven by at least one motor stage to generate rotation in the flow that passes the drum from an upstream end, arranged to receive a multiphase fluid, towards a downstream end arranged to deliver separated fluid phases. By centrifugal action generated by the screw in rotation a heavier fluid phase is forced to exit the drum via the perforations in the drum. The heavier fluid phase is discharged via the annular space, whereas the lighter phase is discharged via the downstream end of the drum.

The internal screw can be realized in the form of a radial blade which is helically turned about a central shaft, the shaft drivingly connected to the open rotor of a PM motor stage. The invention is not limited to a given length, diameter or pitch angle of the internal screw. On the contrary, the invention extends to drums and screws of any length or diameter and includes embodiments with fixed or varying diameter and/or pitch angle along the screw axis. The internal screw may be formed to have one or more entries.

The motor stage can be realized as a permanent magnet motor wherein permanent magnets are carried in the periphery of a radially bladed, open rotor, whereas electromagnets and stator coils are supported on a casing that surrounds the open rotor. The permanent magnets can be arranged on a circular ring member connected to the outer ends of the rotor vanes of a PM motor stage. The permanent magnets can alternatively be supported in the free outer ends of the rotor vanes. In either case the inner ends of the vanes are attached to a rotor shaft which is drivingly coupled to the shaft of the internal screw, directly or indirectly via gear box or other transmission.

Embodiments of the invention comprises a PM motor with a radially bladed rotor wherein the rotor vanes are provided a pitch angle, the rotor thus transferring motor power to the flow. The motor stage(s) of these embodiments can be operated as pump or booster to generate axial flow by the rotor acting as impeller.

Embodiments of the invention further comprise two or more PM motors coupled in an axially stacked motor assembly.

Embodiments of the invention include separator assemblies comprising two or more separator units interconnected in series and aligned in a row for axial flow through all separator units in a row. The separated fluid phases can be discharged via outlets arranged in the last separator unit in the row.

Each separator unit may be individually driven by a separate PM motor stage which is individually powered and controlled. Rotation in the flow can in this way be accelerated successively as the fluid passes the line of separator units.

In one embodiment the separator comprises, as seen in the flow direction, a motor section, a cyclonic section, a spool section, and a separation section with discharge of separated fluid phases.

The motor section comprises one or more PM motor stages with open rotors or impellers at an entry end of the separator assembly. The motor stage(s) drives a rotating drum or internal screw to impart rotation to the flow of multiphase fluid in the cyclonic section. In the spool section the heavier fluid phase accumulates in a radially outer zone as the rotational motion in the flow continues. The fluids of different densities are finally separated and discharged as separate flows from the separation section.

Embodiments of the separator comprise a separate discharge piece formed with passages for separate flows of heavier and lighter fluid phases.

### SHORT DESCRIPTION OF THE DRAWINGS

Embodiments of the invention will now be explained with reference made to the accompanying, schematic drawings. In the drawings,

FIG. 1 is a simplified illustration of separation by cyclonic action,

FIG. 2 is a longitudinal sectional view through a first embodiment of a separator according to the present invention,

FIGS. 3a-3b show a modified embodiment of the separator of FIG. 2,

FIGS. 4a-4c illustrate the separator of the first embodiment in alternative configurations,

FIG. 5 shows a separator assembly comprising multiple separator units,

FIGS. 6a-6b illustrate alternative outlet arrangements,

FIG. 7 shows a second embodiment of the separator in a longitudinal sectional view,

FIGS. 8a-8c illustrate the separator of FIG. 7 in alternative configurations,

FIG. 9 illustrates a first separator assembly, and

FIG. 10 illustrates another separator assembly, both based on a separator according to the present invention.

### DETAILED DESCRIPTION OF PREFERRED EMBODIMENTS

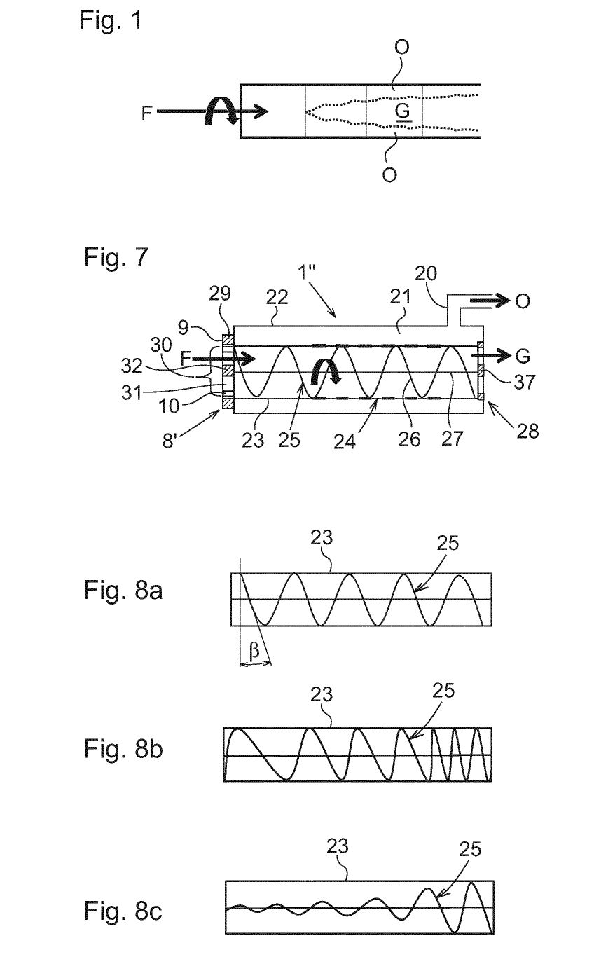

Separation of fluid phases at different densities through centrifugal or cyclonic action is schematically illustrated in FIG. 1. A multiphase fluid flow F is imparted a rotational motion in a confined space, causing the heavier fluid phase O to accumulate in a peripheral and annular zone, whereas the lighter fluid phase G is forced to move inwards towards a central and circular zone.

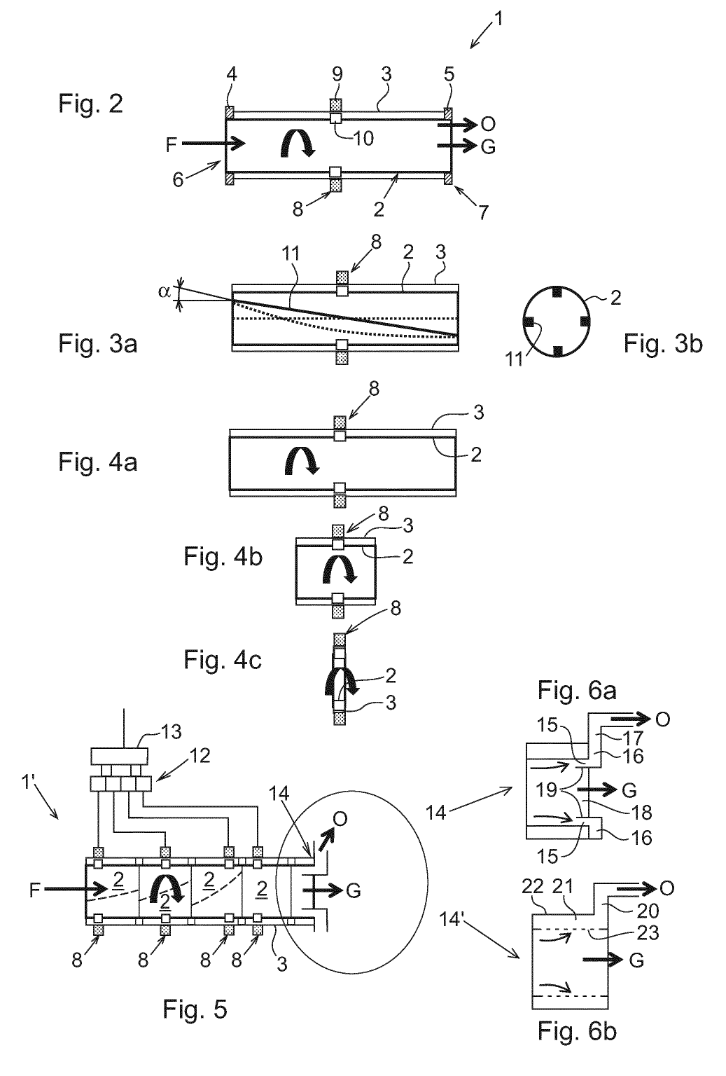

A novel centrifugal separator, which is based on a motor which has an open rotor for fluid to pass through the motor, shall now be described with reference to FIG. 2.

The separator 1 comprises a cylindrical drum 2 which is supported rotationally inside a stationary cylinder 3. The drum can be rotationally journalled in bearings 4 and 5 arranged in the ends of the drum and cylinder. The separator 1 is installed in a multiphase fluid flow F to receive mixed fluid phases via an inlet end 6 and to discharge separated fluid phases O, G via an outlet end 7. Separation of the fluid phases is accomplished by imparting rotational motion in the flow upon passage through the drum 2.

Rotational motion in the flow is generated by a motor 8 which is integrated in the separator and installed in the fluid flow through the separator.

More precisely, the motor 8 is an electric permanent magnet motor 8 comprising electromagnets 9 with stator coils supported on the stationary cylinder 3, whereas permanent magnets 10 are supported on the drum 2. The drum thus constitutes an open rotor which is brought in rotation as the permanent magnets move in the magnetic field which is generated when current is fed to the stator coils for energizing the electromagnets.

The rotary motion of the drum 2 can be transferred to the fluid in alternative ways. In the embodiments shown in FIGS. 3a and 3b a number of wings 11 are arranged projecting inwards from the wall of the drum, the wings running mainly in the longitudinal direction between the inlet and outlet ends of the drum. The wings 11 can have any suitable sectional shape and are not limited to the shape illustrated in the schematic view of FIG. 3b. The internal wings may be oriented in parallel with the longitudinal centre of the drum, as illustrated by the straight dotted line in FIG. 3a. The wings may alternatively be oriented at an angle α relative to the centre line as illustrated through the unbroken line 11 in FIG. 3a. The wings may also be shaped to follow a helical curve in the inner periphery of the drum 2 as illustrated through the curved dotted line in FIG. 3a.

The separator 1 can be of any length down to a minimum length corresponding to the axial dimension of the motor 8, which is illustrated through the picture series of FIGS. 4a-4c.

It should be noted that the invention is not limited to the single motor stage versions illustrated in FIGS. 2-4, and that singular or multiple motor stages can be disposed at substantially any desired location in the longitudinal direction of the separator 1.

A multiple motor stage embodiment shall now be described with reference made to FIG. 5. The separator 1′ of FIG. 5 is a separator assembly composed of four drums 2 in axial alignment, wherein each drum is individually journalled for rotation inside a stationary cylinder 3. Each drum comprises its separate integrated motor 8. The motors 8 can be individually powered and controlled via a dedicated variable speed drive (VSD) boxes 12, which are in turn subordinated a control module 13 configured for distribution of power and signal communication between the separator 1′ and operation control.

By individual regulation of power and speed in the motors 8 the rotational motion in the fluid can be successively increased in the flow direction, from the multiphase inlet to a discharge piece 14 that terminates the in-line separator assembly 1′. To aid in a progressive increase of the rotary motion in fluid, the drums may be formed with internal wings 11 that change in shape and inclination relative to the longitudinal axis, as indicated by the broken lines in FIG. 5.

The discharge piece 14 can be realized in more than one embodiment. FIG. 6a illustrates a discharge piece 14 that has an annular entrance 15 for the heavier phase of the separated flow. The annular entrance opens into a ring-shaped passage 16 which continues into a radial or lateral discharge 17. The annular entrance 15 surrounds an entrance to a central passage 18 for the lighter phase of the separated flow. A circular guide plate 19 may be arranged to extend into the fluid flow upstream of the annular and central entries.

FIG. 6b illustrates a discharge piece 14′ of different design. The embodiment of FIG. 6b comprises a radial or lateral discharge 20 forming an exit from an annular space 21 formed between an outer cylinder 22 and an inner perforated cylinder 23. The annular space 21 receives the heavier fluid phase which is transferred from the inner cylinder via the perforations or slits that are formed in the wall of the inner cylinder. The lighter fluid phase is discharged axially via the downstream end of the inner cylinder.

A second embodiment of the active rotating separator according to the present invention shall now be described with reference made to FIG. 7.

The separator embodiment 1″ of FIG. 7 comprises a stationary outer cylinder 22 in surrounding relation about a stationary inner cylinder or drum 23. The inner drum 23 has a perforated wall wherein openings or slits 24 are formed to permit transfer of a heavier fluid phase from the drum to an annular space 21 defined between the drum and the outer cylinder. A lateral discharge 20 connects to the annular space 21 in radial direction.

A screw 25 is journalled for rotation internally in the drum. The internal screw 25 has a radial blade 26 running helically about a screw shaft 27. The screw shaft 27 is drivingly connected to the rotor of a motor 8′ which is integrated in the separator 1″ and arranged across the fluid flow in the upstream end where the flow of multiphase fluid is received. The non-driven end of the screw is journalled in a bearing support 28 arranged in the downstream end where the separated lighter fluid phase is discharged.

The motor 8′ is an electric permanent magnet motor comprising electromagnets 9 with stator coils supported on a stationary casing 29 whereas permanent magnets 10 are supported on a rotor 30 inside the casing, the rotor brought in rotation as the permanent magnets move in the magnetic field that is generated when current is fed to the stator coils for energizing the electromagnets.

More precisely, in the rotor 30 the permanent magnets are supported in the free outer ends of rotor vanes 31 which extend in radial directions from a rotor shaft 32 that is drivingly coupled to the shaft 27 of the internal screw, directly or indirectly via gear box or other transmission (gear box/transmission not illustrated).

Embodiments includes a PM motor 8′ with a radially bladed rotor 30 wherein the rotor vanes 31 are provided a pitch angle, the rotor 30 thus transferring motor power to the flow. The motor stage(s) of these embodiments can be operated as pump or booster to generate axial flow by the rotor acting as impeller.

Similar to the motor 8′, the bearing support 28 provides an annular passage for through-flow of the fluid.

Alternative designs of the internal screw 25 are illustrated in FIGS. 8a-8c. Accordingly, FIG. 8a shows a screw of fixed pitch angle β and diameter along the axis, FIG. 8b illustrates a screw wherein the pitch angle is varied along the screw axis, whereas FIG. 8c shows a screw wherein the diameter and/or pitch angle is varied along the axis.

As already discussed, embodiments of the invention may include two or more PM motors coupled in an axially stacked motor assembly.

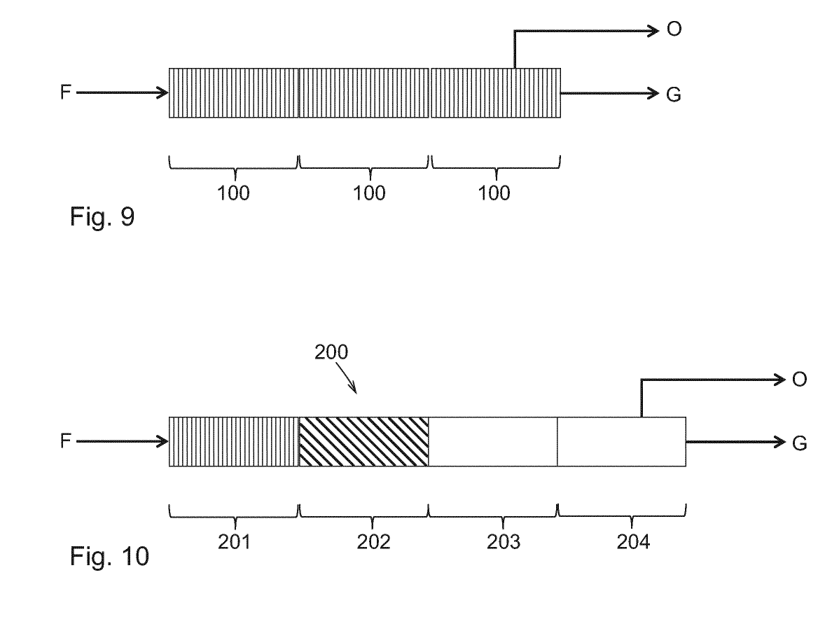

Likewise as previously discussed, embodiments of the invention include separator assemblies, see FIG. 9, having two or more separator units 100 interconnected in series and aligned for axial flow through all separator units in a row. The separated fluid phases can be discharged via outlets arranged in the last separator unit in the row.

The separator units 100 may be individually powered and controlled for individual regulation of the rotational speed of each separator unit 100. Improved separation efficiency can in this way be achieved by smooth increase of the rotational speed. The flow of multiphase fluid first reaches a separator unit with slow rpm, and moves into a unit with slightly increased rpm.

Another embodiment of a separator assembly 200 is illustrated schematically in FIG. 10. The embodiment of FIG. 10 comprises, as seen in the flow direction, a motor section 201, a cyclonic section 202, a spool section 203, and a separation section 204 with discharge of separated fluid phases.

The motor section 201 comprises one or more PM motor stages 8′ with open rotors or impellers at an entry end of the separator assembly. The motor stage(s) drives a rotating drum or internal screw to impart rotation to the flow in the cyclonic section 202. In the spool section 203 the heavier fluid phase accumulates in a radially outer zone as the rotational motion in the flow continues. The fluids of different densities are finally separated and discharged as separate flows from the separation section 204.

Conclusively, the present invention provides a separator using rotating internals to cause separation of fluid phases as well as separation of fluid and solid particles by centrifugal or cyclonic force, independent of flow rate.

The range of application includes
Liquid/solids separation
Gas/liquid separation
Liquid/liquid separation.

The solution presented herein leads to
Improved separation efficiency
Wider operational window
Increased flexibility
Low pressure drop over the separator.

It will be appreciated that modification of the disclosed embodiments is possible without leaving the scope and spirit of the invention as disclosed above and defined in appended claims.

What is claimed is:

1. An active rotating separator comprising:
a separator drum, in an upstream end arranged to receive a multiphase fluid flow and in a downstream end arranged to deliver separated fluid phases;
an electric motor installed in the fluid flow through the drum, the motor operable to rotate the drum and thereby generate rotation in the flow that passes through the drum, the motor comprising an open rotor permitting the fluid to flow through the motor.

2. The separator according to claim 1, wherein the motor is a permanent magnet motor wherein permanent magnets are carried in the rotor periphery and electromagnets and stator coils are supported on a casing surrounding the rotor.

3. The separator according to claim 2, further comprising an inner ring of the permanent magnets and an outer ring of the associated electromagnets and stator coils constitute a motor stage in the separator, wherein the motor stage which can be individually powered and controlled.

4. The separator according to claim 2, wherein the permanent magnets are carried on the periphery of a separator drum which is rotatably supported in an outer cylinder that holds the electromagnets and stator coils in surrounding relation to the drum carrying the permanent magnets.

5. The separator according to claim 1, further comprising at least one rotor wing arranged inside the rotatable drum, the wings reaching inwards from the inner periphery of the drum, and running in the longitudinal direction of the drum.

6. The separator according to claim 5, wherein the wings extend along the inner periphery of the drum at an angle relative to the centre axis which can be zero.

7. The separator according to claim 5, wherein the wings are helically curved.

8. The separator according to claim 1, wherein the motor is located at a longitudinal center of the drum, or located closer to or at the upstream and/or downstream end of the drum.

9. The separator according to claim 8, wherein the motor comprises two or more motor stages, each of which is individually powered and controlled.

10. The separator according to claim 1, wherein the length of the drum can be varied down to the axial dimension of one or more motor stages arranged in series.

11. The separator according to claim 1, further comprising a perforated drum which is non-rotationally supported in a stationary cylinder, the cylinder defining an annular space about the drum, and further comprising an internal screw rotatably arranged in the drum, wherein the internal screw is driven in rotation by at least one motor with an open rotor installed in the fluid flow through the separator.

12. The separator according to claim 11, wherein the internal screw comprises a radial blade which is helically turned about a central shaft, the shaft drivingly connected to the open rotor of a permanent magnet motor.

13. The separator according to claim 11, wherein the internal screw is formed with fixed or varying diameter and/or pitch angle along the screw axis.

14. The separator according to claim 11, wherein the internal screw is formed with one, two or three entries.

15. The separator according to claim 11, wherein the motor is a permanent magnet motor with a radially bladed rotor wherein the rotor vanes are provided a pitch angle, the rotor thus transferring motor power to the flow.

16. The separator according to claim 11, wherein two or more permanent magnet motors are coupled in an axially stacked motor assembly.

17. The separator according to claim 1, further comprising two or more separator units interconnected in series and aligned in a row for axial flow through all separator units in the row.

18. The separator according to claim 17, wherein each of the two or more separator units is individually driven by a separate permanent magnet motor which is individually powered and controlled.

19. The separator according to claim 11, further comprising as seen in the flow direction, a motor section, a cyclonic section, a spool section, and a separation and discharge section.

20. The separator according to claim 19, wherein the motor section comprises one or more permanent magnet motor stages with open rotors or impellers, the cyclonic section comprises a rotating drum or internal screw drivingly connected to the one or more permanent magnet motor stages, the spool section provides an unhindered flow passage for the rotating flow, and the separation section comprises individual passages for the separated fluid phases.

21. (canceled)
